(19) United States
(12) Patent Application Publication
(10) Pub. No.: US 2026/0131535 A1
(43) Pub. Date: May 14, 2026

(54) ACCURATE MODEL-BASED FEEDFORWARD DEPOSITION CONTROL FOR MATERIAL EXTRUSION ADDITIVE MANUFACTURING

(71) Applicant: THE REGENTS OF THE UNIVERSITY OF MICHIGAN, Ann Arbor, MI (US)

(72) Inventors: Pinyi WU, Ann Arbor, MI (US); Keval Ramani, Vasco-Da-Gama (IN); Chinedum E. OKWUDIRE, Birmingham, MI (US)

(73) Assignee: THE REGENTS OF THE UNIVERSITY OF MICHIGAN, Ann Arbor, MI (US)

(21) Appl. No.: 18/686,311

(22) PCT Filed: Aug. 22, 2022
(86) PCT No.: PCT/US2022/041007

§ 371 Date: Feb. 23, 2024

Related U.S. Application Data
(60) Provisional application No. 63/237,233, filed on Aug. 26, 2021.

(51) Int. Cl. B29C 64/393; B29C 64/118; B29C 64/245; B33Y 30/00; B33Y 50/02

(52) U.S. Cl. CPC B29C 64/393; B29C 64/245; B33Y 50/02; B29C 64/118; B33Y 30/00

(57) ABSTRACT

Feedforward control strategies for mitigating over- and under-extrusion defects in material extrusion additive manufacturing, using a standard linear model of extrusion system applied to the feedforward motion control, which has the net effect of synchronizing motion and extrusion control while avoiding some nonlinearities associated with the extrusion process; or an empirical nonlinear model of the extrusion process.

### CROSS-REFERENCE TO RELATED APPLICATIONS

This application claims the benefit of U.S. Provisional Application No. 63/237,233, filed on Aug. 26, 2021. The entire disclosure of the above application is incorporated herein by reference.

### GOVERNMENT SUPPORT

This invention was made with government support under CMMI1825133 awarded by the National Science Foundation. The government has certain rights in the invention.

### FIELD

The present disclosure relates to accurate model-based feedforward (FF) deposition control for material extrusion additive manufacturing.

### BACKGROUND AND SUMMARY

This section provides background information related to the present disclosure which is not necessarily prior art. This section provides a general summary of the disclosure, and is not a comprehensive disclosure of its full scope or all of its features.

Material extrusion (ME) additive manufacturing (AM) is a widely-used manufacturing technology, where 3D parts are built layer-by-layer by extruding material from a nozzle or orifice. ME is the predominant form of AM. It is often achieved via fused deposition modeling (FDM), also known as fused filament fabrication (FFF), where a filament of thermoplastic material is fed into a heated nozzle, then melted polymer is extruded and deposited into desired shapes with the aid of a moving stage (see FIG. 1). Besides plastics, various categories of materials can also be printed via ME AM, e.g., metals, ceramics, biomaterials, and their combinations.

Generally, a ME 3D printer consists of two dynamically dissimilar systems—a slow extrusion system and a fast motion system. High-quality ME deposition demands accurate synchronization between these two systems, as poor synchronization leads to printing defects like over- and under-extrusion (see FIG. 2) during acceleration and deceleration. The dynamics of the fast motion system can be considered as sufficiently linear. Besides, the position of the motion system can be sensed in real-time and corrected by high-bandwidth feedback controllers, leading to very accurate control even in the presence of some nonlinearities. However, extrusion dynamics is highly nonlinear, and difficulties in sensing the real-time extrusion rate limit the application of feedback control to extrusion.

In the literature, feedback control on extrusion has been conducted by regulating extrusion speed and/or force applied to a syringe-type extruder developed for ceramic material-type ME AM, or by regulating the velocity of the gear feeding mechanism in polymer FDM. While these approaches help to improve the deposition accuracy of steady-state extrusion and compensate for the printing defects caused by disturbances, they do not yield satisfactory deposition accuracy during transients in extrusion, when extrusion rate changes. This is in large part due to the fact that these approaches indirectly infer extrusion rate from extruder (e.g., syringe) velocity and/or force. There also exist works where the feedback control is performed from layer to layer. The contour and/or height information of existing layers are captured through camera or laser sensor, and used to calibrate the extrusion command of subsequent layers. However, the non-real-time nature of such methods limits their performance in correcting errors like over- and under-extrusion, arising from transients in extrusion.

Existing extrusion controllers are mostly based on FF approaches. In practice, this is often achieved using a static gain that commands extrusion rate to be proportional to the motion velocity. The gain is pre-tuned by the user through experiments to achieve desired steady-state extrusion cross-sectional (CS) area or width. However, FF extrusion controllers based on the static gain are prone to transient errors like under- and over-extrusion. To address this issue, an approach called linear advance has been developed to compensate for transient defects. It adjusts extrusion rate during acceleration and deceleration of the motion stage using an experimentally determined gain called the K-factor. A similar approach which adjusts process parameters like printing speed and retraction in order to achieve varied extrusion is known. However, these two approaches use kinematics to approximate nonlinear extrusion dynamics, leading to significant inaccuracies.

The state of the art in FF extrusion control is to generate the extrusion commands using first-order linear time-invariant (LTI) models of the extrusion process. However, as shown by Bellini et al., the parameters of such LTI models of the extrusion process vary significantly as functions of the operating condition (e.g., extrusion rate) due to the strong nonlinearity of extrusion dynamics. Therefore, LTI models are only valid for the given operating conditions, and FF extrusion controllers designed based on such LTI first-order models yield inaccurate deposition as the operating condition changes (e.g., change of extrusion command).

FIG. 3 shows a schematic of deposition control in ME. It requires the synchronization of two control systems—motion control and extrusion control. The key task of the motion controller is to cause the actual velocity Vₐ of a motion stage to follow a desired velocity Vₐ by manipulating a commanded velocity V_{c}. Similarly, the extrusion controller seeks to force the actual (volumetric) extrusion rate Qₐ to follow the desired extrusion rate Q_{d} by manipulating extrusion command Q_{c}. Note that in practice, instead of manipulating Q_{c} directly, the extrusion process is controlled through altering the material feeding velocity v (e.g., the gear velocity in FIG. 1). This is because Q_{c} is proportional to feeding velocity command v_{c}, i.e., Q_{c}=kv_{c}, where k is a proportionality constant dependent on the size of the orifice and properties of the extruded material. Therefore, in the present disclosure, v_{c} is used as a proxy for Q_{c}, together with vₐ=Qₐ/k and v_{d}=Q_{d}/k serving as proxies for Qₐ and Q_{d}, respectively (see FIG. 3). In practice, v_{d} is often commanded to be proportional to the desired motion velocity v_{d} using a static gain a called the extrusion multiplier (EM), i.e., v_{d}=αV_{d}. The value of α is usually pre-tuned by the user through experiments to achieve desired steady-state extrusion cross-sectional (CS) area or width. The synchronization between the motion and extrusion control systems is tied to the relationship between the CS area, extrusion rate and motion velocity, i.e.:

$${A}_{d} = \frac{{Q}_{d}}{{V}_{d}} = k α ; {A}_{a} = \frac{{Q}_{a}}{{V}_{a}} = {kv}_{a} / {V}_{a} \qquad ( 1 )$$

where A_{d} and Aₐ are respectively the desired and actual CS areas of the deposited track; accurate synchronization is achieved when Aₐ≈A_{d}. The motion dynamics and controller are represented by G_{M} and C_{M}, respectively. Without loss of generality, G_{M}=C_{M}=1 is assumed in this section, meaning that Vₐ=Vₐ. This is because, relative to extrusion dynamics, motion dynamics is much faster and accurate. This simplifying assumption allows us to focus on the nonlinear extrusion dynamics (G_{E}) and the extrusion controller (C_{E}), which are the bottlenecks for accurate synchronization of the two control systems, and hence bottlenecks for accurate deposition control.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a deposition process of FDM, a common form of ME AM.

FIG. 2 is an over- and under-extrusion defects due to poor synchronization of motion and extrusion control.

FIG. 3 is an accurate deposition in ME is achieved via Synchronizing Motion and Extrusion Control Systems.

FIG. 4 is an experimental setup.

FIG. 5 is a printed track for K identification.

FIG. 6 is a typical shape of the printed track for system identification.

FIG. 7 is a measured, desired and fitted width curves.

FIG. 8 is a camera mount platform.

FIGS. 9A-9C show a captured image of printed track, edge captured from binary image, and measured width of track in pixels, respectively.

FIG. 10 is a measured extrusion velocity and fitted curve.

FIG. 11 is an iterative learning process for nonlinear extrusion control.

FIG. 12A-12B is an uncompensated result and compensated result with state-of-the-art FF extrusion control, respectively.

FIGS. 13A-13C shows uncompensated result, compensated result with standard FF extrusion control, and compensated result with Approach 1, respectively.

FIG. 14 is a velocity profile of standard approaches and Approach 1.

FIG. 15 is a fitted surface and surface connected measured points.

FIGS. 16A-16D show uncompensated results, compensated result with standard FF extrusion control, and compensated result with Approach 1, and compensated result with Approach 2, respectively.

FIGS. 17A-17D shows uncompensated result, compensated result with standard FF extrusion control, compensated result with Approach 1, and compensated result with Approach 2, respectively.

FIGS. 18A-18D shows model of part with variable-width pattern using CONVEX and Printed variable-width pattern based on uncompensated, compensated result with standard FF control, compensated results with Approach 1, and compensated results with Approach 2, respectively.

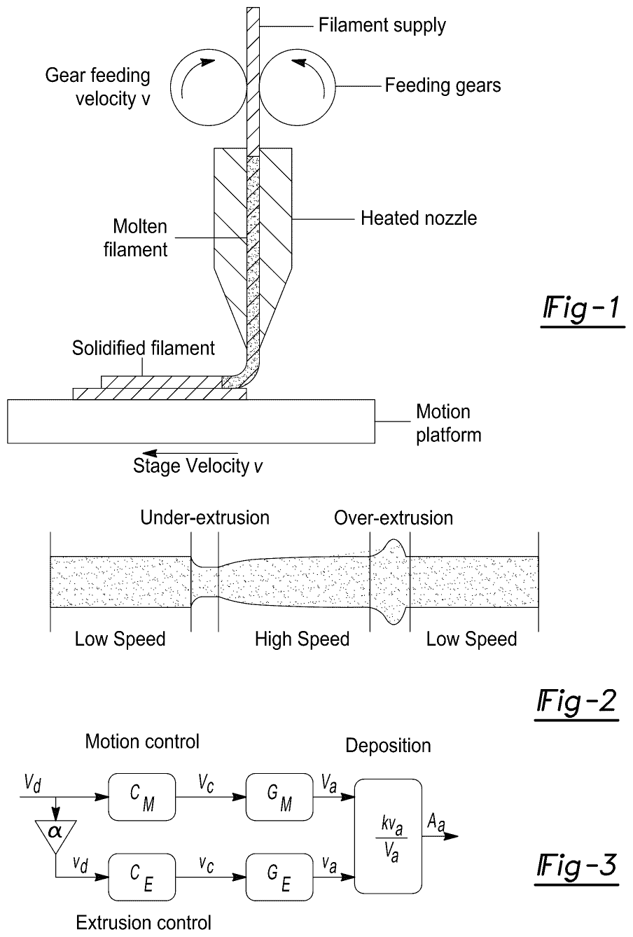

Table 1 identifies time constants.

Table 2 shows maximum deposition error.

Table 3 shows maximum deposition error.

Table 4 shows maximum deposition error.

Table 5 shows the values of v_{c} and vₐ and the resulting t.

Table 6 shows maximum deposition error.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

According to the principles of the present disclosure, two feedforward (FF) control strategies for mitigating over- and under-extrusion defects in ME AM are provided. The first strategy uses a standard linear model of extrusion system but applies it to FF motion control rather than FF extrusion control. This has the net effect of synchronizing motion and extrusion control while avoiding some nonlinearities associated with the extrusion process. In the second approach, an empirical nonlinear model of the extrusion process is developed and adopted for the design of a nonlinear FF extrusion controller. Both approaches were validated experimentally on a fused deposition modeling (FDM) 3D printer, and respectively demonstrated up to 40.45% and 35.98% improvement in deposition accuracy (i.e., reduced over- and under-extrusion) compared to a standard FF extrusion control approach typically used in the literature. In addition, the presented nonlinear FF controller was shown to be more versatile and lead to faster ME AM compared to the presented linear FF motion control approach. A practical application of the presented techniques for improving the quality of a variable-width pattern printed using a new concept of continuously varied extrusion was demonstrated.

In greater detail, the state of the art in FF extrusion control is to determine a linear (and time-invariant) model Ĝ_{E} of the actual extrusion dynamics G_{E}. Theoretically, accurate extrusion control could be achieved by adopting a model-inversion based FF controller, i.e., C_{E}=Ĝ_{E}⁻¹. If Ĝ_{E}≈G_{E}, then from FIG. 3,

$${A}_{a} = \frac{{Q}_{a}}{{V}_{a}} = \frac{{kv}_{a}}{{V}_{a}} = k {\hat{G}}_{E}^{\_ 1} {G}_{E} {aV}_{d} / {V}_{d} \to {A}_{a} \approx {A}_{d} \qquad ( 2 )$$

However, the problem with this approach is that the linear model Ĝ_{E} is only accurate for the extrusion conditions under which it was identified since G_{E} is highly nonlinear. This issue was also discussed by Bellini et al., who proposed the following first-order linear time-invariant (LTI) model for Ĝ_{E} (given by the transfer function below)

$${\hat{G}}_{E} = \frac{{Q}_{a}}{{Q}_{c}} = \frac{{v}_{a}}{{v}_{c}} = \frac{K}{τ s + 1} exp ( - Ts ) \qquad ( 3 )$$

where s is the Laplace variable, τ is the time constant, T is the time delay and K is the gain. The parameters τ, T and K vary significantly for different extrusion rates. As a result, Ĝ_{E}≠G_{E} as v_{c} changes due to the FF extrusion controller. Hence, Aₐ≈A_{d} is not achieved using this linear model in the standard extrusion control process of Eq. (2). The practical implications of this problem are demonstrated in experimental results presented herein.

To address the aforementioned shortcomings of existing FF extrusion control techniques, this disclosure makes the following original contributions:

It proposes a new way (hereafter referred to as Approach 1) to use simple LTI models to achieve excellent deposition accuracy in ME AM. Approach 1 involves applying simple LTI models to motion control rather than to extrusion control, thus avoiding some errors caused by nonlinear extrusion dynamics. The upside of Approach 1 is that it is relatively simple, but its downsides are that it is not as versatile and it slows down the deposition process.

To address the shortcomings of Approach 1, this disclosure proposes another way (hereafter referred to as Approach 2). It involves empirically deriving a first-order nonlinear model for extrusion and designing a nonlinear FF extrusion control method based on the nonlinear model.

On an FDM 3D printer, this disclosure experimentally demonstrates significant improvements in deposition accuracy using Approaches 1 and 2, compared to a state-of-the-art approach. It also demonstrates the versatility and higher deposition speed of Approach 2 relative to Approach 1. Lastly, it demonstrates a practical application of the presented techniques for improving the quality of a variable-width pattern printed using a new concept of continuously varied extrusion (CONVEX).

The rest of this disclosure is organized as follows: experimental methodology, theoretical derivation, and analysis of Approach 1 and Approach 2 are presented; experimental results are presented to reveal the practical problem of using LTI models for FF extrusion control and demonstrate the effectiveness of Approach 1 and Approach 2; and conclusions and future work are discussed.

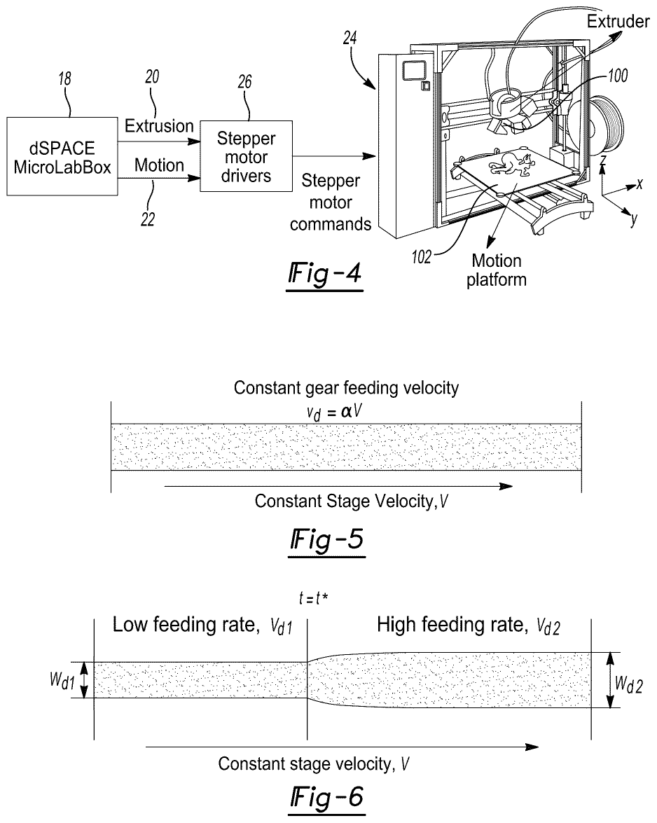

Experiments are conducted on a Lulzbot Taz 6 FDM 3D printer (shown in FIG. 4) using PLA filament. The extruder 100 and motion platform 102 are controlled by a real-time control board (dSPACE MicroLabBox) 18; the extrusion commands 20 and motion commands 22 are sent to the stepper motors 24 on the 3D printer at 1 KHz sampling rate via stepper motor drivers 26 (Pololu DRV8825). The following experimental setup is used to identify the parameters of Ĝ_{E} given in Eq. (3) and evaluate the accuracy of applying the state-of-the-art and proposed FF extrusion control strategies.

To identify the gain K in Eq. (3), straight tracks are printed under motion velocities, Vₐ=Vₐ=V, varying from 10-100 mm/s and corresponding extrusion rates, by using a constant EM (α=0.02) as shown in FIG. 5. Note that α=0.02 is used for experiments throughout this disclosure. The EM is proportional to the desired CS area (A_{d}) of printed tracks, as shown in Eq. (1). Moreover, assuming that the height of printed tracks is constant, the desired width (W_{d}) and actual width (Wₐ) of the tracks are proportional to A_{d} and Aₐ, respectively. Therefore, Wₐ can be used as a proxy for its CS area, Aₐ, to evaluate synchronization accuracy, as also adopted in. It is observed that the maximum width deviation of the printed track is less than 6% compared to the mean width. Besides, considering the limited compressibility of the molten filament, mass conservation assumption is valid for the deposition process, i.e., fed material amount equals to the extruded material amount, hence K=1 is employed in this disclosure.

To identify τ and T, single tracks are deposited along the x-axis of the printer by commanding the stage to travel at a constant speed V, i.e., Vₐ=Vₐ=V. As the stage travels, a step velocity command, changing from v_{d1} to v_{d2}, is sent to the extruder at time t=t*. FIG. 6 shows a typical shape of the printing pattern, where the slow response of extrusion system to a step command is observed.

Equation (3) could be re-written as:

$${\hat{G}}_{E} = \frac{{v}_{a}}{{v}_{c}} = \frac{1}{τ s + 1} \qquad ( 4 )$$

Notice that T=0 in Eq. (4) because negligible delay between extrusion command and extrusion response is observed in the system identification experiments. Similar observations have been made by other researchers. Therefore, the focus of the system identification is on the time constant, τ. As τ is a measure of how quick the first-order system responds to the step input, track width history for the step extrusion input is adequate to identify the time constant. Track width information along the extruded line is captured by camera and measured through image processing using MATLAB. The camera set up and image processing procedure are described herein. Based on the fact that the transition from W_{d1} to W_{d2} is a step command, Wₐ can be described by the following response when applied to the first order extrusion dynamics described in Eq. (5)

$${W}_{a} = {W}_{d 2} + ( {W}_{d 1} - {W}_{d 2} ) exp ( - \frac{t}{τ} ) \qquad ( 5 )$$

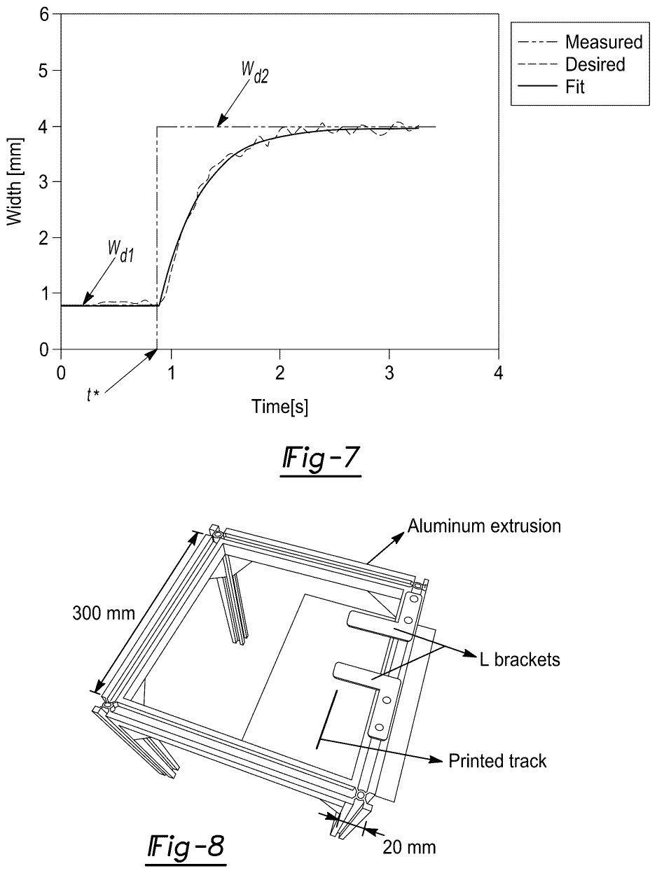

Applying least-squares fitting to the measured Wₐ, the time constant τ can be uniquely determined. FIG. 7 shows an example of a desired width W_{d}, actual width Wₐ measured using a digital camera and fitted width curve for v_{d1}=0.2 mm/s and v_{d2}=1 mm/s.

Hardware set up: A high-resolution (12 mega pixel) cellphone camera capable of generating image of size 4032×3024 is adopted to capture the image of printed tracks. A camera mount frame was built to guarantee that the camera is leveled horizontally to the printed track, as shown in FIG. 8. The platform was built with eight 300 mm-long aluminum extrusions, two L brackets were fixed to one of the top aluminum extrusions for the camera's placement. The printed tracks were placed on a contrasting background under the L brackets to improve the accuracy of image processing.

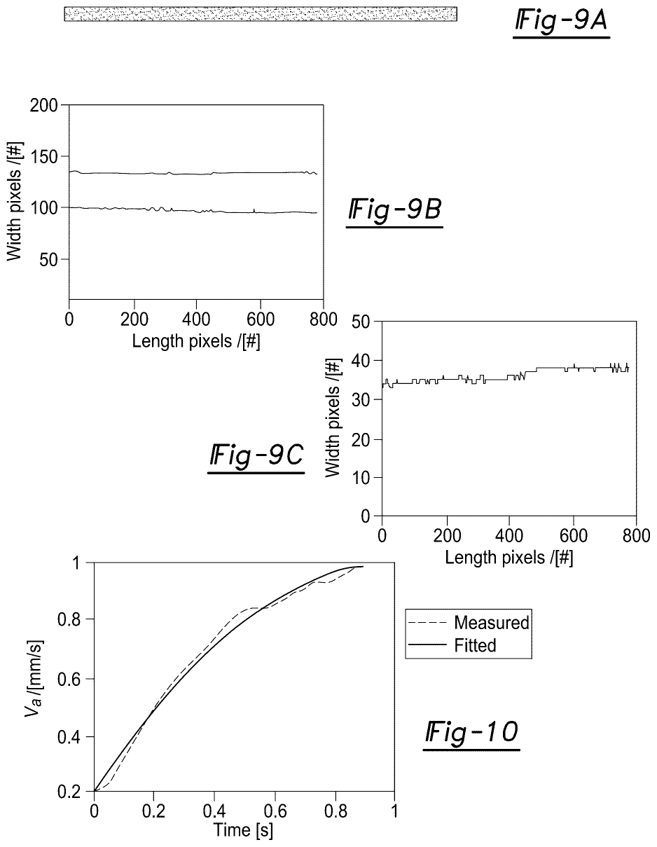

Image processing procedure: The captured image (see FIG. 9A) was first converted into a gray scale image (using MATLAB's rgb2gray command), then the image was further converted into binary image with a threshold value determined through trial and error (using MATLAB imbinarize command), where the region of printed track is represented by 1 and the background is represented by 0. The edge (using MATLAB edge command) of the track in the binary image is then captured (see FIG. 9B) and its width can be measured from the binary image, as shown in FIG. 9C). The pixel number can be converted to length through a series of benchmarking tests. With the current set up, the resolution of the measurements is 0.0608 mm/pixel.

As described herein, the standard FF extrusion control using Eq. (2) is susceptible to the nonlinear nature of the extrusion system and leads to inaccurate control. A major reason for this is that Ĝ_{E} used for extrusion control is a linear approximation of the nonlinear G_{E}. Therefore, for Ĝ_{E} to yield accurate extrusion control, the extrusion dynamics must stay close to the operating condition under which it was identified. However, during extrusion control using Ĝ_{E}, the feeding velocity v_{c} used to compensate for extrusion errors may force the system to deviate from the operating condition under which Ĝ_{E} was identified, leading to significant error.

To avoid errors due to change of operating condition caused by v_{c}, by Approach 1 maintaining v_{c}=vₐ and, instead, uses Ĝ_{E} to alter motion command velocity V_{c} to achieve accurate deposition control. Referring back to FIG. 3, in Approach 1, V_{c} is obtained by filtering V_{d} with Ĝ_{E} (i.e., C_{M}=Ĝ_{E}) while keeping v_{c}=v_{d} (i.e., C_{E}=1). Then, theoretically,

$${A}_{a} = \frac{{kv}_{a}}{{V}_{a}} = {akV}_{d} {G}_{E} / {V}_{d} {\hat{G}}_{E} \to {A}_{a} \approx {A}_{d} \qquad ( 6 )$$

In other words, theoretically, Eq. (6) achieves the same result as the standard extrusion control approach of Eq. (2). However, it accomplishes this by leaving v_{c} unchanged hence does not alter the accuracy of Ĝ_{E}. It is shown herein that Approach 1 improves deposition accuracy relative to the state of the art. However, it reduces deposition speed and loses its accuracy when extrusion commands are varied (i.e., it is not versatile).

In Approach 2, a nonlinear model-based extrusion controller is presented to address the limitations of Approach 1 with regards to deposition speed and versatility. First, a nonlinear model is empirically derived and identified, then a nonlinear FF extrusion control approach is presented based on it.

Assuming the first order dynamics of Eq. (4) between v_{c} and vₐ in Ĝ_{E}, in the presented nonlinear model, the time constant T is assumed to be an unknown nonlinear function of v_{c} and vₐ. The structure and parameters of the unknown nonlinear function are determined empirically. Accordingly, the nonlinear relationship between v_{c} and vₐ can be written as:

$${v}_{a} = ( {v}_{c} - {v}_{a} ) / τ ( {v}_{a} , {v}_{c} ) \qquad ( 7 )$$

To identify τ(vₐ, v_{c}), the time constant data points can be obtained using Eq. (8) with system input v_{c} known and output vₐ measured using image processing.

$$τ ( {v}_{a} , {v}_{c} ) = ( {v}_{c} - {v}_{a} ) / {v}_{a} \qquad ( 8 )$$

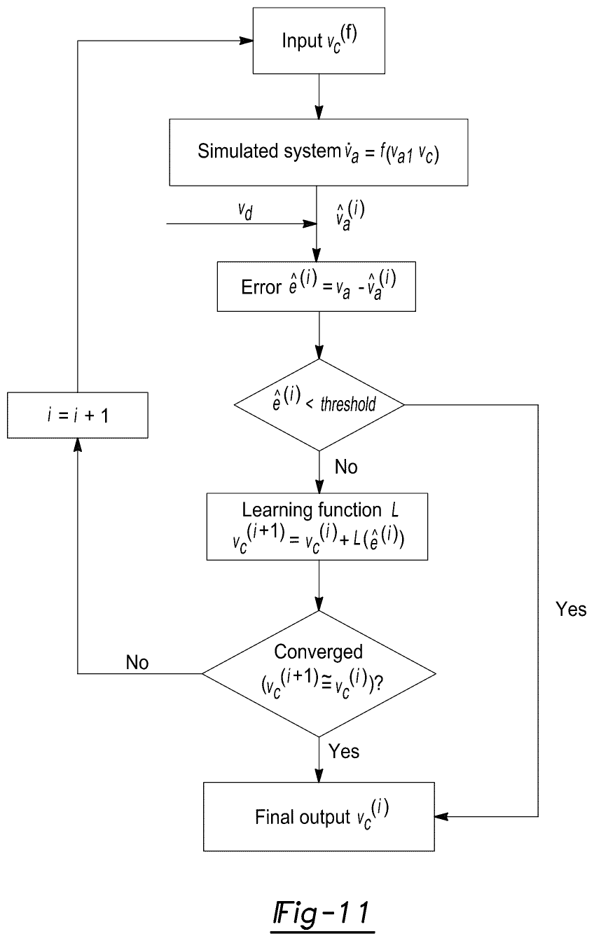

To mitigate the error caused by noise from the image processing procedure, the measured vₐ is fitted using a quadratic function of time. FIG. 10 shows the measured vₐ and corresponding fitted curve for set with v_{d1}=0.2 mm/s and δv_{d}=0.8 mm/s, where the fitted function is vₐ=0.756812+1.55 t+0.2 mm/s. Then the time derivative \dot{v}ₐ of the curve-fitted vₐ is adopted for computation of τ using Eq. (8). With obtained data points of τ, vₐ and v_{c}, the nonlinear function τ(vₐ, v_{c}) can be determined using surface fitting.

With the nonlinear extrusion model known, a model inversion-based FF extrusion controller is presented. Since an explicit inversion of a nonlinear system can be challenging to obtain, a learning control law is adopted to compute the extrusion controller's command, v_{c}, iteratively. The learning process is shown in FIG. 11. The superscript i indicates the iteration number; \hat{v}ₐ is adopted to represent the simulated output instead of vₐ, and ê is the simulated error which equals v_{d}−\hat{v}ₐ. The iteration is initialized with an initial guess of v_{c}. then, in the ith iteration, v_{c}⁽ⁱ⁾ is applied to the nonlinear extrusion model of Eq. (7), and the simulated error ê⁽ⁱ⁾ is computed using the simulated output \hat{v}_{c}⁽ⁱ⁾ from the nonlinear model. Then the system input v_{c} for the next (i+1th) iteration is updated through a learning function L according to Eq. (9):

$${v}_{c}^{( i + 1 )} = {v}_{c}^{( i )} + L ( {\hat{e}}^{( i )} \qquad ( 9 )$$

The iteration stops when v_{c} converges (i.e., v⁽ⁱ⁺¹⁾≅v⁽ⁱ⁾ or ê⁽ⁱ⁾ is smaller than a preset threshold, and the obtained v_{c} is selected as the input to the actual system.

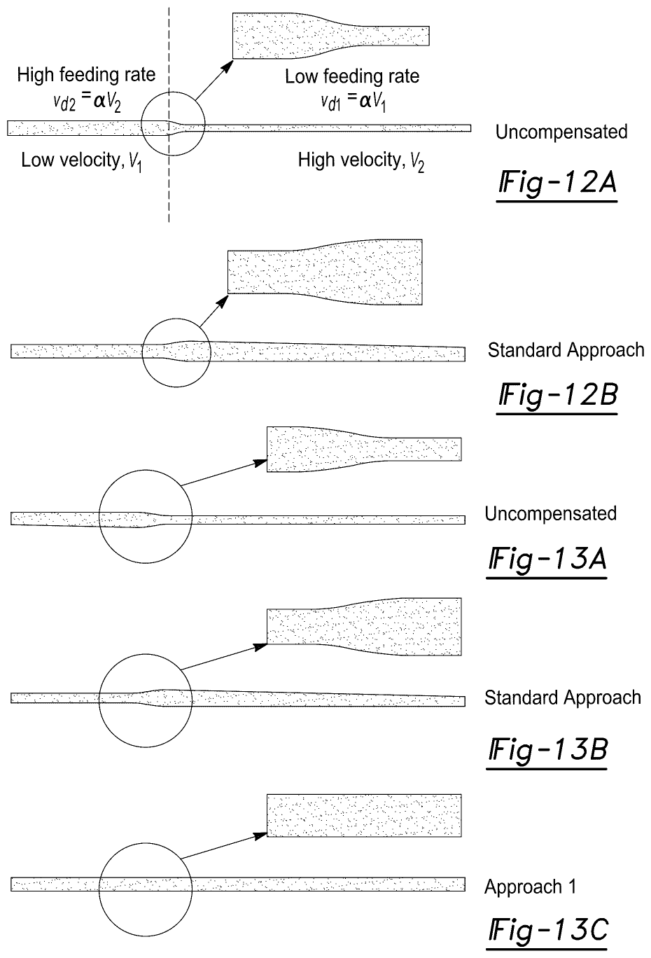

The identified first-order models are adopted as Ĝ_{E} to design the FF extrusion controller using Eq. (2) (i.e., C_{E}=Ĝ_{E}⁻¹) and the controllers are applied to compensate for the under-extrusion that appears in the printing pattern shown in FIG. 2. Table 1 reports the identified time constants as a function of v_{d1} and δv_{d}=v_{d2}−v_{d1}. Notice that τ could vary up to almost 10 times for various values of v_{d1} and δv_{d}. This underscores the high degree of nonlinearity in extrusion dynamics. FIG. 12A shows the tracks printed with V₁=10 mm/s and V₂=50 mm/s without compensation (i.e., v_{c1}=v_{d1}=αV₁ and v_{c2}=v_{d2}=αV₂); and FIG. 12B shows the printed tracks with FF compensation using Eq. (2), where for Ĝ_{E}, τ=0.367 s based on the corresponding value identified for v_{d1}=0.2 mm/s and δv_{d}=0.8 mm/s (see Table 1). Notice that in both cases significant deposition errors are incurred at t* and beyond, due to inaccurate extrusion control. The maximum deposition error can be quantified using image processing as 44.72% and 42.13% with and without compensation, respectively, calculated using Eq. (10)

$${e}_{max} = max ( {W}_{d} - {W}_{a} ) / {W}_{d} \qquad ( 10 )$$

The same experiments are repeated for every combination of v_{d1} and δv_{d} in Table 1, and the deposition errors without compensation and with compensation using Eq. (2) for each case are presented in Table 2 and Table 3, respectively. The compensation reduces the maximum error by up to 26.77%, relative to the case without compensation. Note that, although the FF extrusion control using Eq. (2) reduces transient defects, the maximum, mean and standard deviation of the deposition errors in Table 3 are 44.72%, 13.32% and 12.70%, which are high. Thus, the standard extrusion control strategy is not sufficiently accurate nor precise.

Herein, the effectiveness of Approach 1 is validated through experiments, where the motion controller was also adopted to compensate for the under-extrusion defect presented in FIG. 2 and FIG. 12A. FIG. 13A shows the printed track with V₁=10 mm/s and V₂=50 mm/s without compensation (i.e., v_{d1}=0.2 mm/s and v_{d2}=1 mm/s), FIG. 13B shows the printed track with FF compensation using Eq. (2); and FIG. 13C shows the printed track with compensation using Approach 1. It is noticed that Approach 1 significantly mitigates the under-extrusion defects incurred at t*, as the maximum deposition errors are quantified as 46.40%, 44.40% and 2.80% for FIGS. 13A, 13B and 13C, respectively. Similar experiments are also repeated for all combinations of v_{d1} and δv_{d}, the quantified maximum deposition errors for each case are presented in Table 4. It is observed that Approach 1 significantly mitigates the transient defect with compensation error lower than 9.7% in all cases (shown in Table 4), the experiments demonstrate 44.15%, 22.78% and 10.53% improvement, respectively, in the maximum, mean and standard deviation of deposition error compared to those without compensation; and 40.45%, 10.50% and 10.19% improvement, respectively, in the maximum, mean and standard deviation of deposition error compared to the standard FF extrusion control using Eq. (2).

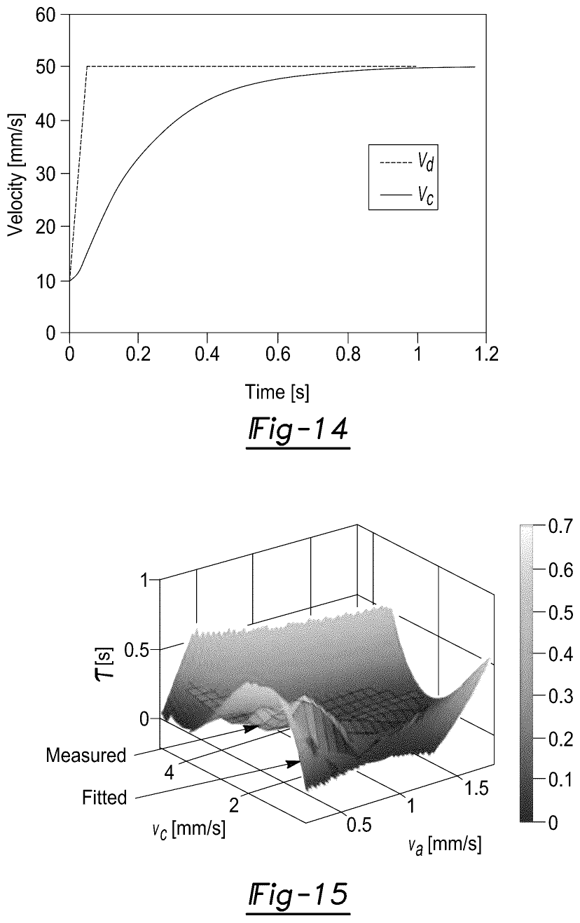

However, Approach 1 slows the printing process down by filtering the desired velocity command Vₐ with Ĝ_{E}. An example is shown in FIG. 14 to compare the unfiltered Vₐ and obtained V_{c} of set 10-50 mm/s, where it takes 16.4% (0.164 s) longer for the motion-controlled platform to traverse a 49 mm-long straight line, resulting in loss of productivity relative to the uncompensated or standard FF compensation approaches. Another shortcoming of Approach 1 (which also applies to the standard approach of Eq. (2)) is that it is not versatile. A specific model (i.e., time constant in Ĝ_{E}) must be used for FF control under each operating condition (i.e., each vd1 and δv_{d} pair). This limits the ability of the controller to alter extrusion velocity (operating condition) during printing without significantly diminishing accuracy, as is demonstrated herein below.

Herein as follows, we validate Approach 2 experimentally. First the time constant function is obtained using the data points from identification experiments of (v_{d1} to v_{d2}) sets shown in Table 5.

Without loss of generality, the time constant points cloud is fitted by a cubic surface. In FIG. 15, the surface with denser grids and without edge indicates the fitted result, and the adopted data points cloud is represented by the surface with sparser grids and edge. The function of the fitted surface is shown as Eq. (11)

$$τ ( {v}_{a} , {v}_{c} ) = - 0.014 - 1.05 {v}_{a} + 1.2 {v}_{c} + 0.2425 {v}_{a}^{2} + 0.5 {v}_{a} {v}_{c} - 0.6 {v}_{c}^{2} + 0.3125 {v}_{a}^{3} - 0.6 {v}_{a}^{2} {v}_{c} + 0.0775 {v}_{a} {v}_{c}^{2} + 0.06875 {v}_{c}^{3} \qquad ( 11 )$$

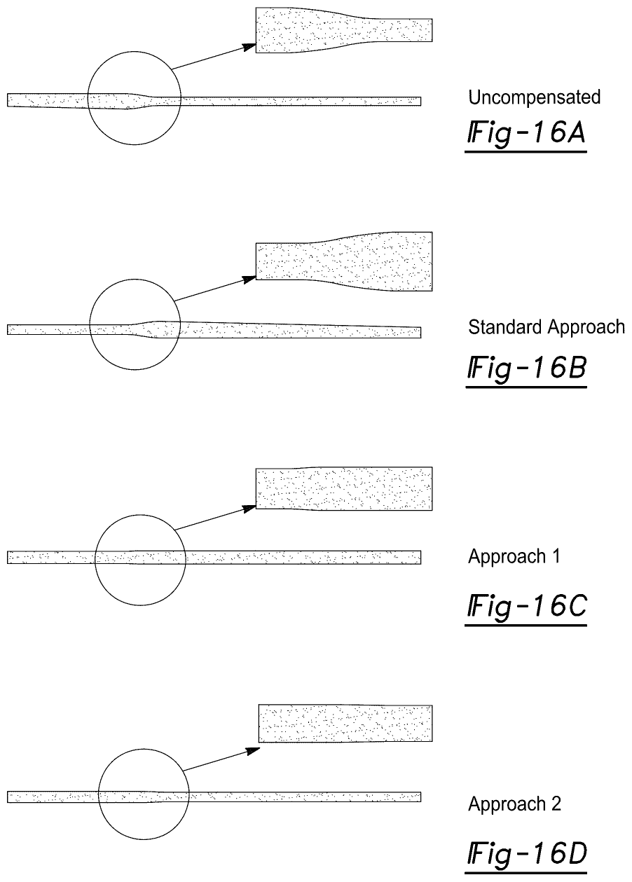

Experiments are conducted to validate the effectiveness of the presented extrusion controller. The learning function is simply chosen to be a proportional-derivative (PD) controller, whose learning control law is given mathematically by

$${v}_{c}^{( i + 1 )} = {v}_{c}^{( i )} + {W}_{p}^{*} {e}^{( i )} + \frac{{W}_{d}^{*} {de}^{( i )}}{dt} \qquad ( 12 )$$

where Wₚ and W_{d} are the proportional gain and derivative gain, respectively selected as 0.4 and 0.8 by trial and error, and the threshold for ending the iteration is selected as 0.006 mm/s. FIG. 16 shows the printed tracks without compensation, with standard FF extrusion control using Eq. (2), with compensation using Approach 1 and with compensation using Approach 2 for compensating the under-extrusion defects in FIG. 2 and FIG. 12A with v_{d1}=0.2 mm/s and v_{d2}=1 mm/s, respectively in FIG. 16A-16D. Similar experiments are repeated for all combinations of v_{d1} and δv_{d} in Table 1 and the quantified deposition errors using Eq. (10) are presented in Table 6. It is observed that Approach 2 significantly improves the deposition accuracy, demonstrating up to 42.46% and 35.98% improvement in compensating the deposition error compared to the uncompensated results and compensated results with FF extrusion compensation using Eq. (2), respectively. Although the compensation error using Approach 2 is higher than the ones using Approach 1 in some cases, Approach 2 achieves satisfactory compensation accuracy with a maximum error less than 10% in all cases without compromising extrusion speed because, unlike Approach 1 (e.g., see FIG. 14), it does not slow down the motion command.

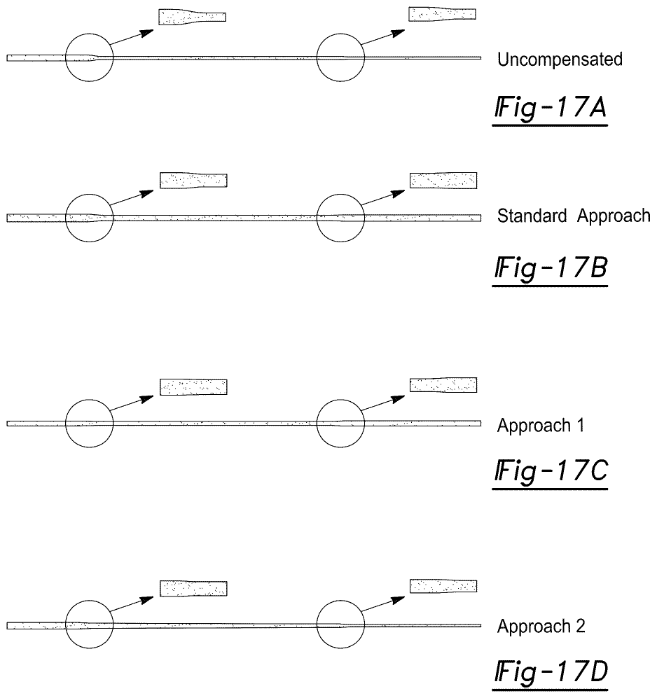

Moreover, note that in Approach 1, a linear model is identified for each operating point (i.e., each v_{d1} and δv_{d} combination). In evaluating the accuracy of Approach 1, each linear model was applied to the operating condition for which it was derived. However, this approach is not practical in many ME AM scenarios where operating conditions (e.g., extrusion speed) could vary within one print. Switching to a new LTI model for each new operating condition is impractical. The more likely way of applying LTI models is to select one LTI model that best represents all operating conditions. For example, in Bellini et al., an LTI model whose time constant was the average of three obtained time constants was chosen as the general model of the extrusion system. Approach 2 overcomes this shortcoming of LTI models by using a single nonlinear model to represent all operating conditions. To illustrate this benefit, consider a case study where v_{d} changes from 0.2 mm/s to 0.8 mm/s then to 1.4 mm/s (see FIG. 17(a)). Approach 1 and the standard extrusion control using Eq. (2) are used for compensation using an “average” LTI model (using τ=0.187 s, a middle value of time constants in Table 1). Approach 2 is also applied to the case study. FIG. 17A shows the printed track without compensation; FIGS. 17B-17C respectively show the printed tracks with standard FF compensation using Eq. (2) and with Approach 1, based on the Ĝ_{E} with τ=0.187 s; FIG. 17D shows the printed track with FF compensation using Approach 2. Approach 1 leads to 13.3% and 3.7% maximum deposition error during the first and second velocity transition as highlighted in FIG. 17(c); standard FF extrusion compensation leads to 17.2% and 11.1% maximum deposition error for the first and second velocity transition as highlighted in FIG. 17(b), while Approach 2 achieves high deposition accuracy with lower errors of 0% and 5.26%. This shows that Approach 2 is more versatile and accurate when applied to practical situations where operating conditions could vary.

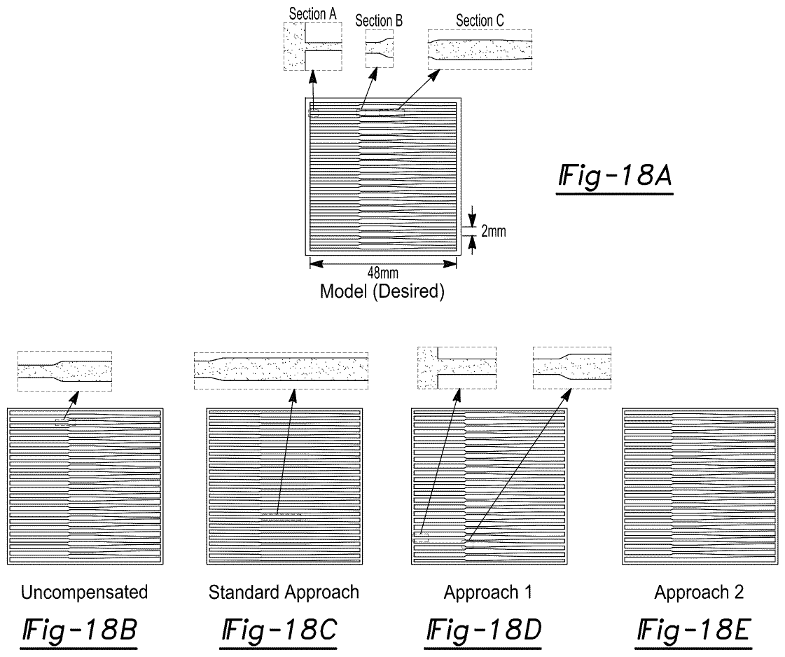

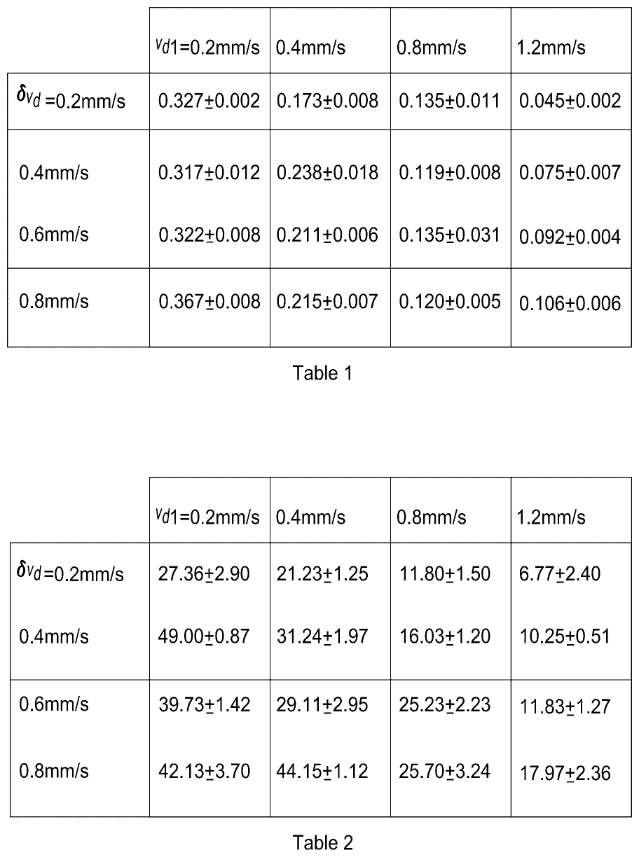

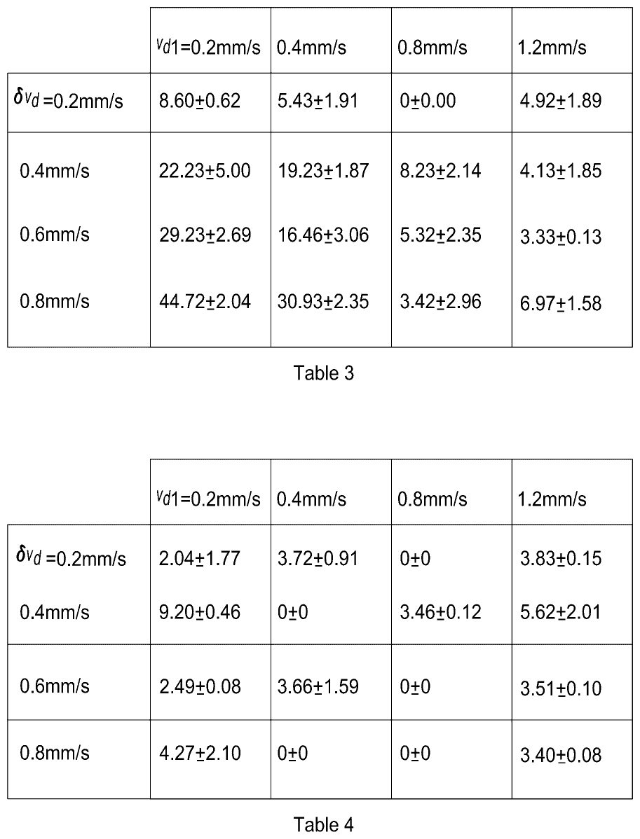

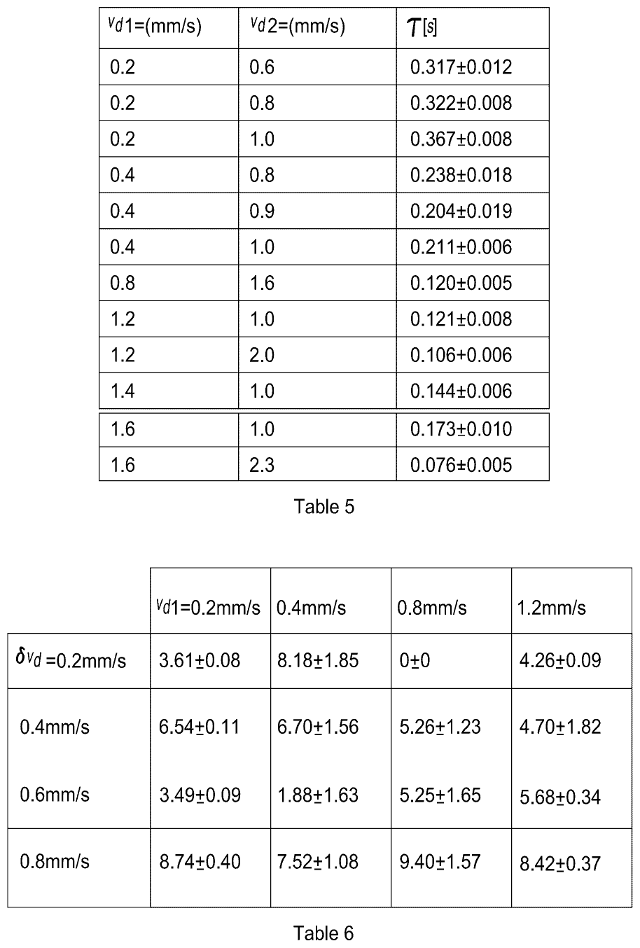

One practical application of the presented approaches is to a new concept of continuously varied extrusion (CONVEX) proposed by Moetazedian et al., CONVEX enables additive manufacturing of variable-width patterns by continuously varying the extrusion command along a deposition path. To demonstrate this, consider the pattern shown in FIG. 18A. The width of its interior tracks is designed to vary along their lengths. To achieve this, the stage velocity is held constant at V=10 mm/s along each track. Each track could be divided into three sections of interest (see FIG. 18A). In Section A, the track width is held constant by commanding a constant extrusion speed of v_{d}=0.2 mm/s. Then, in Section B, the track width is increased rapidly by ramping up the extrusion speed from v_{d}=0.2 mm/s to v_{d}=0.6 mm/s at a rate of 4 mm/s2. Finally, in Section C, the track width is narrowed down gradually by reducing extrusion speed from v_{d}=0.6 mm/s to v_{d}=0.2 mm/s at a rate of 0.33 mm/s2.

FIG. 18B presents the printed pattern without compensation; FIGS. 18C-18D respectively show the pattern printed using the standard approach and Approach 1, based on the Ĝ_{E} with τ=0.317 s; FIG. 18E shows the printed pattern using Approach 2. As highlighted by the bright yellow dashed lines in the zoomed-in portions of the figures, the uncompensated width increase in Section B is much slower than desired in FIG. 18B. The standard LTI approach tracks the sharp increase in width in Section B reasonably well but over compensates leading to over extrusion in Section C. Approach 1 attempts to track the sharp width increase in Section B but it experiences significant errors due to the fact that the LTI model used for control is identified for step inputs and is not versatile enough to be used for the ramp increase (i.e., changing operating condition). Besides, Approach 1 takes 9.2 s (4%) longer to print the pattern compared to the other methods. Approach 1 also incurs significant errors at the beginning of Section A due to improper compensation. The effectiveness and versatility of Approach 2 are demonstrated by the relatively high tracking accuracy of the variable extrusion width in Sections B without leading to over compensation in Section C nor excessive extrusion at the beginning of Section A. It therefore enables the most accurate reproduction of the variable width pattern and can thus facilitate advanced extrusion approaches like CONVEX.

This disclosure has presented two FF control approaches for addressing inaccuracies in synchronizing extrusion and motion control in ME AM that commonly lead to deposition errors like under- and over-extrusion. It has shown that, in large part, these inaccuracies stem from the nonlinearity in the dynamics of extrusion. The state of the art is to compensate deposition errors in feedforward by altering extrusion command using linear models. However, this practice is shown to yield inaccurate deposition control because the extrusion command causes the extrusion dynamics to stray away from the operating conditions for which the linear model was identified.

The first approach (Approach 1) presented in this disclosure relies on the same linear models used in the state-of-the-art (standard) FF extrusion control approaches. However, rather than using the linear model to alter extrusion command it uses the linear model to alter the motion command (e.g., of the build platform's motion). Consequently, Approach 1 compensates deposition errors in feedforward without changing the operating condition of the nonlinear extrusion dynamics from that of the linear model used for compensation. The result is that Approach 1 achieves up to 40.45% reduction in deposition error compared to the standard approach when applied to an FDM 3D printer.

Two challenges with Approach 1 are highlighted, namely: it slows down the extrusion process and it loses its accuracy when operating condition (e.g., extrusion speed) changes. Both of these issues have practical ramifications in terms of reducing the productivity and flexibility of ME AM. To address them, a second approach (Approach 2) is presented where a nonlinear model of extrusion dynamics is derived empirically and used to design a nonlinear controller that alters extrusion command. The nonlinear controller of Approach 2 is shown to be up to 35.98% more accurate than the standard approach without slowing down the extrusion process. However, unlike Approach 1, it remains accurate with changing operating points, hence, it is more versatile, as demonstrated using a practical case study involving the printing of variable-width patterns by continuously varied extrusion CONVEX. One downside of Approach 2 relative to Approach 1 is that it is a bit more complex to derive.

From a practical standpoint, the presented methods (and the standard approach) are likely to require a new/updated model for each printer and material. Therefore, system identification of the linear or nonlinear model must be streamlined and made easy. One way this can be accomplished is to include a (cellphone-grade) camera on ME printers together with a set of system identification procedures like those used in this disclosure. This could be an avenue for future work. From a theoretical perspective, there may be value in exploring alternative linear or nonlinear models and controllers to improve the accuracy of the presented approaches.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A feedforward deposition system for a material extrusion additive manufacturing system, the feedforward deposition system comprising:
an extrusion control system configured to extrude a material to define an item to be printed via the material extrusion additive manufacturing system;
a motion control system configured to move a platform relative to the extrusion control system using a drive system, the platform configured to support the item to be printed; and
a feedforward control system operably coupled to the motion control system and configured to control the movement of the platform relative to the extrusion control system, the feedforward control system configured to output command signals to the drive system of the motion control system.

2. The feedforward deposition system according to claim 1 wherein the feedforward control system is configured to output command signals to the extrusion control system.

3. The feedforward deposition system according to claim 1 wherein the feedforward control system is configured to control the movement of the platform relative to the extrusion control system based on an actual extrusion rate from the extrusion control system.

4. The feedforward deposition system according to claim 1 wherein the feedforward control system is configured to control the movement of the platform relative to the extrusion control system in real time.

5. A feedforward deposition system for a material extrusion additive manufacturing system, the feedforward deposition system comprising:
an extrusion control system configured to extrude a material to define an item to be printed via the material extrusion additive manufacturing system;
a motion control system configured to move a platform relative to the extrusion control system using a drive system, the platform configured to support the item to be printed; and
a feedforward control system operably coupled to the extrusion control system and configured to control the extrusion control system based on an empirically derived first-order nonlinear model of the extrusion process, the feedforward control system configured to output command signals to the extrusion control system.

6. The feedforward deposition system according to claim 5 wherein the empirically derived first-order nonlinear model is applied to all data points of the command signals.

7. The feedforward deposition system according to claim 5 wherein the feedforward control system is configured to output command signals to the motion control system.

8. The feedforward deposition system according to claim 7 wherein the feedforward control system is configured to control the extrusion control system based on an actual extrusion rate from the extrusion control system.

9. The feedforward deposition system according to claim 5 wherein the feedforward control system is configured to control the extrusion control system in real time.

10. The feedforward deposition system according to claim 5 wherein the extrusion control system is configured to output a variable width extrusion.
